(19) United States
(12) Patent Application Publication
(10) Pub. No.: US 2005/0019011 A1
(43) Pub. Date: Jan. 27, 2005

(54) Information recording apparatus, information recording method, information recording program and information recording medium

(75) Inventor: Hidenori Takeda, Tokorozawa-shi (JP)

Correspondence Address: MORGAN LEWIS & BOCKIUS LLP, 1111 PENNSYLVANIA AVENUE NW, WASHINGTON, DC, 20004, US

(73) Assignee: PIONEER CORPORATION

(21) Appl. No.: 10/896,878

(22) Filed: Jul. 23, 2004

(30) Foreign Application Priority Data
Jul. 25, 2003 (JP) P2003-201757

(51) Int. Cl. H04N 5/91

(52) U.S. Cl. 386/83

(57) ABSTRACT

A information-recording apparatus is provided with: a first programming device that is used for programming the execution of the recording processes of recording to the medium and the other medium; a second programming device that is used for programming the execution of the detection/recording process that uses the other medium entered start time information that indicates the start time for executing the detection/recording process; a calculation device which calculates the end time for the detection/recording process based on the information that is the object of the detection/recording process, and the input start time information; a judgment device which determines, based on end time information that indicates the calculated end time and the entered start time information, whether or not the recording process of recording onto the other medium and the detection/recording process are programmed to be executed at the same time; and an output device which outputs notification information.

### BACKGROUND OF THE INVENTION

1. Field of the Invention

This invention relates to a information-recording apparatus, information-recording method, information-recording program and information-recording medium; and more particularly relates to a information-recording apparatus and information-recording method capable of recording information to both a recording medium such as a hard disc and to another recording medium such as a DVD (Digital Versatile Disc), and to a information-recording program and information-recording medium on which that information-recording program is recorded.

2. Related Art

In recent years, recorders are commercially sold that are capable of recording information such as broadcast program information that is sent via a received broadcast signal onto various kinds of recording media including a magnetic recording medium like a hard disc and an optical recording medium like a optical disc; and are capable of executing so-called dubbing, which is transferring or copying information that is temporarily recorded on a magnetic recording medium to an optical recording medium

Also, with this kind of recorder, it is possible to program the recorder so that it starts the recording process or dubbing of the information described above at a preset time.

However, with the conventional recorder described above, automatically adjusting the time for executing the recording process and the time for executing the dubbing onto each recording medium is not taken into consideration, and when these execution times overlap, there was a problem in that the user must consider each of the execution times and re-program one of the times.

Also, in this case, it is not possible to efficiently combine both the recording process and dubbing, so there is a possibility that due to an oversight on the part of the user, that one of the two processes will not be performed properly.

### SUMMARY OF THE INVENTION

Taking the above problems into consideration, it is the object of this invention to provide a information-recording apparatus, information-recording method, information-recording program and recording medium on which the information-recording program is recorded that make it possible to efficiently execute these processes when it is possible to record to different recording media and perform dubbing between those recording media.

The above object of the present invention can be achieved by a information-recording apparatus. The information-recording apparatus that performs at least: a detection/recording process of detecting information from one recording medium and recording that detected information to another recording medium, a detection/recording process of re-recording information detected from the recording medium onto that the medium itself, or a detection/recording process of re-recording information detected from the other recording medium onto that the other medium itself; a recording process of recording information onto the recording medium; and a recording process of recording information onto the other medium; and for which executing at least the recording process of recording onto the other medium or the detection/recording process of using the other recording medium at the same time is prohibited, is provided with: a first programming device that is used for programming the execution of the recording processes of recording to the recording medium and the other recording medium; a second programming device that is used for programming the execution of the detection/recording process that uses the other recording medium by entering start time information that indicates the start time for executing the detection/recording process that uses the other recording medium; a calculation device which calculates the end time for the detection/recording process that uses the other recording medium based on the information that is the object of the detection/recording process that uses the other medium, and input start time information, when execution of the detection/recording process that uses the other recording medium is programmed; a judgment device which determines, based on end time information that indicates the calculated end time and the entered start time information, whether or not the recording process of recording onto the other recording medium and the detection/recording process that uses the other recording medium are programmed to be executed at the same time; and an output device which outputs notification information for notifying that execution of the recording process and the detection/recording process that uses the other recording medium at the same time is prohibited, when the recording process of recording onto the other recording medium and the detection/recording process that use the other recording medium are programmed to be executed at the same time.

According to the present invention, with the dubbing process which includes a dubbing-programming process, when the execution time of the recording process to a recording medium is programmed such that it overlaps with the execution time of the dubbing process, a notification is given indicating that that operation is prohibited, so by changing the execution time for the dubbing process according to that notification, it is possible to efficiently perform both the recording process and dubbing process to the recording medium.

In one aspect of the present invention can be achieved by the information-recording apparatus of the present invention. The information-recording apparatus of the present invention is, wherein when recording of the information onto the recording medium accompanies an encoding process; the judgment device which determines, based on end time information that indicates the calculated end time and input start time information, whether or not the recording process of recording onto the recording medium and the detection/recording process that uses the recording medium are programmed to be executed at the same time; and when the recording process of recording onto the recording medium and the detection/recording process that uses the recording medium are programmed to be executed at the same time, further determines whether or not the detection/recording process that uses the recording medium is performed together with a decoding process and the encoding process that is performed on the information that becomes the object of the detection/recording process that uses the recording medium; and wherein the output device which outputs notification information for notifying that execution of the recording process of recording to the recording medium and the detection/recording process that uses that recording medium at the same time is prohibited, when the recording process of recording onto the recording medium and the detection/recording process that uses the recording medium are programmed to be executed at the same time, and when it is determined that the detection/recording process that uses the recording medium is performed together with the decoding process and the encoding process.

According to the present invention, when the execution time for a recording process is programmed such that it overlaps the execution time of a rate-conversion dubbing process that requires execution of the same encoding process, a notification is given indicating that that operation is prohibited, so by changing the execution time of the rate-conversion dubbing process according to that notification, it is possible to efficiently execute both the recording process and rate-conversion dubbing process that require execution of the same encoding process.

In another aspect of the present invention can be achieved by the information-recording apparatus of the present invention. The information-recording apparatus of the present invention, is further provided with: a search device which searches for an executable time, which is a time when it is possible to execute one of the detection/recording processes, based on the programmed time for executing one of the process when at least the recording process of recording onto the other recording medium or the recording process of recording onto the recording medium, and one of the detection/recording processes are programmed to be executed at the same time; and a change device which changes the contents of the programmed time for executing one of the detection/recording processes such that the detection/recording process is executed at the found executable time.

According to the present invention, with the dubbing process of the present invention, when the execution time for the recording process is programmed such that it overlaps the execution time for the dubbing process, the programmed time for executing the dubbing process is changed so that it corresponds to the execution time of the recording process, and free time is used to efficiently end the dubbing process.

In further aspect of the present invention can be achieved by the information-recording apparatus of the present invention. The information-recording apparatus of the present invention is, wherein when a plurality of the executable times are found, the change device changes the programmed contents such that one of the detection/recording processes is divided and executed according to the plurality of the executable times.

According to the present invention, since the programmed time for execution of the dubbing process is set to correspond with the execution time for the recording process, it is possible to efficiently complete the dubbing process using the free time.

In further aspect of the present invention can be achieved by the information-recording apparatus of the present invention. The information-recording apparatus of the present invention is, wherein when the start time information is input, the change device changes the programmed contents such that one of the detection/recording processes is divided and executed in order from the earliest executable time of the executable times after the start time.

According to the present invention, after the time for starting the dubbing process is input, that dubbing process is executed using the free times after that input time, so it is possible to efficiently execute the dubbing process after the specified start time. When there is a new programmed recording process while waiting for the start time, that new programmed recording process has priority, and construction is possible in which after knowing the contents of the new programmed recording process the process of dividing the programmed contents for the dubbing process is performed again.

In further aspect of the present invention can be achieved by the information-recording apparatus of the present invention. The information-recording apparatus of the present invention is further provided with a third programming device which is used for programming execution of one of the detection/recording processes by entering end time information indicating the end time for execution of one of the detection/recording processes; and wherein when the end time information is entered, the change device changes the programmed contents such that one of the detection/recording processes is divided and executed in order going back to the executable time indicating the earliest time of executable times before the end time.

According to the present invention, after the end time for the dubbing process has been input, the dubbing process is executed using the free time in order going back from that time, so it is possible to efficiently execute the dubbing process up to the specified end time.

The above object of the present invention can be achieved by a information-recording method. The information-recording method that performs at least: a detection/recording process of detecting information from one recording medium and recording that detected information to other recording medium, a detection/recording process of re-recording information detected from the recording medium onto that the medium itself, or a detection/recording process of re-recording information detected from the other recording medium onto that the other medium itself; a recording process of recording information onto the recording medium; and a recording process of recording information onto the other medium; and for which executing at least the recording process of recording onto the other medium or the detection/recording process of using the other recording medium at the same time is prohibited, is provided with: a first programming process of programming the execution of the recording processes of recording to the recording medium and the other recording medium; a second programming process of programming the execution of the detection/recording process that uses the other recording medium by entering start time information that indicates the start time for executing the detection/recording process that uses the other recording medium; a calculation process of calculating the end time for the detection/recording process that uses the other recording medium based on the information that is the object of the detection/recording process that uses the other medium, and input start time information, when execution of the detection/recording process that uses the other recording medium is programmed; a judgment process of determining, based on end time information that indicates the calculated end time and input start time information, whether or not the recording process of recording onto the other recording medium and the detection/recording process that uses the other recording medium are programmed to be executed at the same time; and an output process of outputting notification information for notifying that execution of the recording process and the detection/recording process that uses the other recording medium at the same time is prohibited, when the recording process of recording onto the other recording medium and the detection/recording process that use the other recording medium are executed at the same time.

The above object of the present invention can be achieved by a information-recording program. The information-recording program that makes a computer included in a information-recording apparatus that performs at least: a detection/recording process of detecting information from one recording medium and recording that detected information to other recording medium, a detection/recording process of re-recording information detected from the recording medium onto that the medium itself, or a detection/recording process of re-recording information detected from the other recording medium onto that the other medium itself; a recording process of recording information onto the recording medium; and a recording process of recording information onto the other medium; and for which executing at least the recording process of recording onto the other medium or the detection/recording process of using the other recording medium at the same time is prohibited, function as: a first programming device that is used for programming the execution of the recording processes of recording to the recording medium and the other recording medium; a second programming device that is used for programming the execution of the detection/recording process that uses the other recording medium by entering start time information that indicates the start time for executing the detection/recording process that uses the other recording medium; a calculation device of calculating the end time for the detection/recording process that uses the other recording medium based on the information that is the object of the detection/recording process that uses the other medium, and input start time information, when execution of the detection/recording process that uses the other recording medium is programmed; a judgment device of determining, based on end time information that indicates the calculated end time and input start time information, whether or not the recording process of recording onto the other recording medium and the detection/recording process that uses the other recording medium are programmed to be executed at the same time; and an output device of outputting notification information for notifying that execution of the recording process and the detection/recording process that uses the other recording medium at the same time is prohibited, when the recording process of recording onto the other recording medium and the detection/recording process that use the other recording medium are executed at the same time.

According to the present invention, with the dubbing process which includes a dubbing-programming process, when the execution time of the recording process to a recording medium is programmed such that it overlaps with the execution time of the dubbing process, a notification is given indicating that that operation is prohibited, so by changing the execution time for the dubbing process according to that notification, it is possible to efficiently perform both the recording process and dubbing process to the recording medium.

### BRIEF DESCRIPTION OF THE DRAWINGS

FIG. 1 is a block diagram showing the main construction of the recorder of this invention;

FIG. 2 is a flowchart showing the dubbing of a first embodiment of the invention;

FIG. 3A is a drawing showing an example of the initial screen that are displayed when executing the dubbing of a first embodiment of the invention;

FIG. 3B is a drawing showing an example of the program-information screen that are displayed when executing the dubbing of a first embodiment of the invention;

FIG. 4A is a drawing showing an example of the program screen that are displayed when executing the dubbing of the first embodiment of the invention;

FIG. 4B is a drawing showing an example of the confirmation screen that are displayed when executing the dubbing of the first embodiment of the invention;

FIG. 5 is a flowchart showing the dubbing of a second embodiment of the invention;

FIG. 6A is a drawing showing an example of the program screen of the second embodiment of the present invention;

FIG. 6B is a concept drawing that explains this dubbing of the second embodiment of the present invention; and

FIG. 7 is a drawing showing an example of the confirmation screen that is displayed when executing dubbing of the second embodiment of the invention.

### DESCRIPTION OF THE PREFERRED EMBODIMENTS

Next, the preferred embodiments of the invention will be explained based on the drawings. The embodiment explained below, is an embodiment in which the invention is applied to a recorder as the recording apparatus that records a broadcast program to a hard disc (hereafter, referred to as a HD) and a DVD.

(I) Recorder

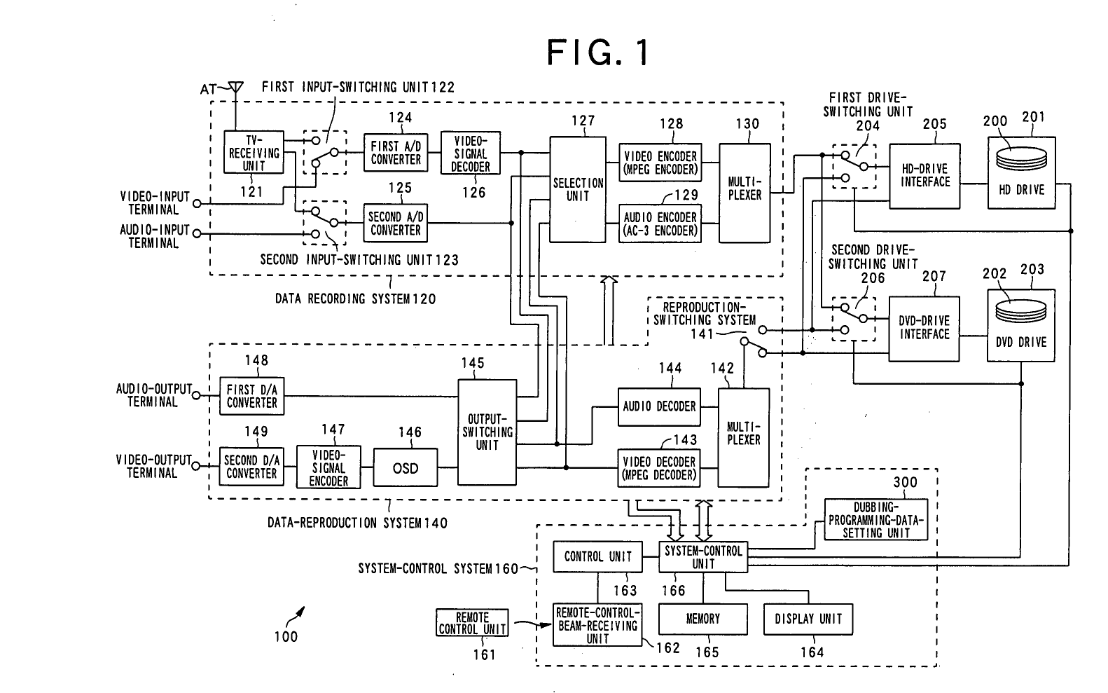

First, before explaining the embodiment in detail, the overall construction and operation of the recorder of this embodiment will be explained using FIG. 1. FIG. 1 is a block diagram showing the main construction of the recorder of this embodiment.

As shown in FIG. 1, the recorder 100 of this embodiment comprises: a HD drive 201 that writes information to or reads information from a HD 200 that is one recording medium on which video information and audio information are recorded; a DVD drive 203 as a recording means that writes information to or reads the information from a DVD 202 that is another recording medium on which video information and audio information are recorded; a information-recording system 120 into which video information and audio information such as the video signal and audio signal of a broadcast program are input, and records that video information and audio information onto a HD 200 or DVD 202; a information-reproduction system 140 that reads the already recorded video information and audio information from the HD 200 or DVD 202; and a system-control system 160 that controls the information-recording system 120 and information-reproduction system 140.

Here, a first drive-switching unit 204 that switches between the output from the DVD drive 203 and the output from the information-recording system 120, and a HD-drive interface 205 that complies to a standard such as ATAPI (AT Attachment Packet Interface) are connected to the HD drive 201, and the first drive-switching unit 204 switches the input and output according to control from a system-control unit 166 that is described later.

Also, this HD drive 201 reads program streams from the HD 200, which contain video information and audio information and that are recorded in advance on the HD 200, and outputs them to the information-reproduction system 140 by way of the HD drive interface 205, and records programs streams, which are created by the information-recording system 120 and are input by way of the HD drive interface 205, to the HD 200.

Moreover, a second drive-switching unit 206 that switches between the output from the HD drive 201 or the output from the information-recording system 120, and a DVD drive interface 207 that complies to a standard such as ATAPI are connected to the DVD drive 203, and similar to the first drive-switching unit 204, this second drive-switching unit 206 performs switching of the input and output according to control from the system-control unit 166 that will be described later.

Also, similar to the HD drive 201, this DVD drive 203 reads program streams from the DVD 200 that contain video information and audio information that are recorded beforehand, and outputs the streams to the information-reproduction system 140 by way of the DVD drive interface; and also by way of the DVD drive interface, records program streams to the DVD 202 that were created by the information-recording system 120.

Next, details of the construction and operation of the information-recording system 120 of the recorder 100 of the recorder of this embodiment will be explained.

The information-recording system 120 of the recorder 100 of this embodiment comprises: a TV receiving unit 121 that, by way of an antenna AT, receives broadcast signals that are sent from broadcast stations; a first input-switching unit 122 and second input-switching unit 123 that switch between analog video signals and audio signals that are input from the outside by way of a video-input terminal and audio-input terminal, and the output from the TV receiving unit 121; a first analog-to-digital (hereafter referred to as A/D) converter 124 that converts the received or input TV video signal to a digital signal; a second A/D converter 125 that converts a received or input audio signal to a digital signal; a video-signal decoder 126 that decodes the TV video signal, which was converted to a digital signal, to a video signal; a selection unit 127 that selects the video signal and audio signal to encode; a video encoder 128 that converts the video signal that was selected by the selection unit 127 to MPEG (Motion Picture Expert Group) format; an audio encoder 129 that converts the audio signal that was selected by the selection unit 127 to AC (Audio Coding)-3 format; and a multiplexer 130 that generates a program stream from the MPEG format video information and AC-3 format audio information.

The TV receiving unit 121 receives, by way of an antenna AT, a broadcast signal, for example an RF signal such as a VHF or BS signal, that is sent from a broadcast station, and together with converting the received signal wave that is tuned to a receiving range that is selected by the user to an IF (intermediate frequency) signal, it demodulates the signal to a TV video signal and audio signal and outputs them to the first input-switching unit 122.

Also, the TV video signals that are output from the TV receiving unit 121 and analog video signals that are input from the outside by way of the video-input terminal are input to the first input-switching unit 122, and this first input-switching unit 122 selectively switches between these input TV video signals based on control from the system-control system 160, and outputs the video signal to the first A/D converter 124.

On the other hand, the audio signal that is output from the TV receiving unit 121 and the analog audio signal that is input from the outside by way of the audio-input terminal are input to the second input-switching unit 123, and this second input-switching unit 123 selectively switches between these input audio signals based on control from the system-control unit 160 and outputs the signal to the second A/D converter 125.

Moreover, the TV video signal, which is the analog signal that was selected by the first input-switching unit 122, is input to the first A/D converter 124, and this first A/D converter 124 converts the TV video signal, which is the input analog signal, to a digital signal and outputs it to the video-signal decoder 126.

After that, the TV signal that has been converter to a digital signal is input to the video-signal decoder 126, and this video-signal decoder 126 decodes the input TV video signal and converts it to a normal video signal, for example, a NTSC format video signal. Also, this video-signal converter 126 outputs the converted video signal to the selection unit 127.

On the other hand, the audio signal, which is the analog signal that was selected by the second input-switching unit 123, is input to the second A/D converter 125, and this second A/D converter 125 converts the audio signal, which is the input analog signal, to a digital signal and outputs it to the selection unit 127.

The video signal and audio signal that were output from the video-signal decoder 126 and second A/D converter 125, and the decoded video signal and audio signal that were output from the HD drive 201 or DVD drive 203 when performing dubbing, as will be described later, are input to the selection unit 127. This selection unit 127 selects one of the input video signals and audio signals based on control from the system-control system 160, and outputs the selected video signal to the video encoder 128 and outputs the selected audio signal to the audio encoder 129.

By doing this, the video signal that was selected by the selection unit 127 is input to the video encoder 128, and this video encoder 128 converts the input video signal to MPEG format video information, and outputs that converted video information to the multiplexer 130.

On the other hand, the audio signal that was selected by the selection unit 127 is input to the audio encoder 129, and this audio encoder 129 converts the input video signal to AC-3 format audio information, and outputs that converted audio information to the multiplexer 130.

Moreover, the video information converted to MPEG format and the audio information converted to AC-3 format are input to the multiplexer 130, and this multiplexer 130, together with generating a program stream based on the input video information and audio information, outputs that generated program stream to the first drive-switching unit 204 and second drive-switching unit 206.

Next, details of the construction and operation of the information-reproduction system 140 of the recorder 100 of this embodiment will be explained.

The information-reproduction system 140 of the recorder 100 of this embodiment comprises: a reproduction-switching unit 141 that selects either the reproduction output from the HD 200 or the reproduction output from the DVD 202; a de-multiplexer 142 that extracts the audio information and video information, which are output from the HD drive 201 or DVD drive 203, from the program stream; a video decoder 143 and audio decoder 144 as a reproduction means that decodes the video signal and audio signal that are separated by this de-multiplexer 142; an output-switching unit 145 that switches between the video signal and audio signal that were output from the video decoder 143 and audio decoder 144, and the video signal and audio signal that were output from the TV receiving unit 121; a thumbnail OSD (On Screen Display) 146 that generates thumbnails (so-called representative images) that are to be superimposed over the image that is displayed on the monitor to be described later; a video-signal encoder 147 that converts the signal to a TV signal; a second digital-to-analog (hereafter referred to as D/A) converter 149 that converts the video signal, which is a digital signal, to an analog signal; and a first D/A converter 148 that converts the audio signal, which is a digital signal, to an analog signal; and wherein the video signal and audio signal that are converted to analog signals are output to the outside by way of a video-output terminal and audio-output terminal.

At this time, the program stream that is output from the HD drive 201 by way of the HD-drive interface 205 and the program stream that is output from the DVD drive 203 by way of the DVD-drive interface 207 are input to the reproduction-switching unit 141, and this reproduction-switching unit 141 selects one of the program streams that is output from one of the drives based on control from the system-control unit 166, and outputs the selected program stream to the de-multiplexer 142.

The program stream that was selected by the reproduction-switching unit 141 is input to the de-multiplexer 142, and this de-multiplexer 142 separates the video information and audio information from the input program stream, and then outputs the separated video information and audio information to the video decoder 143 and audio decoder 144, respectively.

Particularly, this de-multiplexer 142 separates video information from the program stream that has MPEG format, and audio information that has AC-3 format.

Video information having MPEG format that was separated from the program stream is input to the video decoder 143, and this video decoder 143 decodes the input MPEG formatted video information and converts it to a video signal, and outputs that video signal, which is a decoded digital signal, to the output-switching unit 145.

On the other hand, the audio information having AC-3format that was separated from the program stream is input to the audio decoder 144, and this audio decoder 144 decodes the input AC-3 formatted audio information and converts it to an audio signal, and outputs the audio signal, which is a decoded digital signal, to the output-switching unit 145.

The video signal and audio signal, which are digital signals output from the information-recording system 120, and the video signal and audio signal that are decoded by the video decoder 143 and audio decoder 144 are input to the output-switching unit 145, and this output-switching unit 145, based on control from the system-control unit 166, switches between the video signal and audio signal that are output from the information-recording system 120 and the decoded video and audio signal, and outputs the video signal to the OSD 146, and outputs the audio signal to the first D/A converter 148.

In this embodiment, the video signal that is output from the video-signal decoder 126 and the audio signal that is output from the second A/D converter 125 are input to the output-switching unit 145.

Also, the video signal that is switched by the output-switching unit 145 is input to the OSD 146, and this OSD 146 superimposes the necessary text information over the input video signal, and outputs this video signal with superimposed text information to the video-signal encoder 147.

In this embodiment, when performing dubbing as will be described later, the OSD 146 generates video information showing the contents of the dubbing list based on an instruction from the system-control system 160, and superimposes the generated video information onto the input video signal or switches from the input video signal and outputs it to the video-signal encoder 147.

Also, the video information that corresponds to the dubbing list generated as mentioned above by the OSD 146 of this embodiment will be described in detail later.

On the other hand, the video signal, onto which the text information has been superimposed, is input to the video-signal encoder 147, and in order to display this input video signal to an external monitor or the like, this video-signal encoder 147 converts the signal to TV video format and then outputs the video signal converted to TV format to the second D/A converter 149.

The video signal, which is a digital signal that is converted to TV format, is input to the second D/A converter 149, and this second D/A converter 149 converts the video signal, which is this input digital signal, to an analog signal, and outputs the video signal that has been converted to an analog signal to the outside by way of the video-output terminal.

Moreover, the audio signal, which is the digital signal switched to by the output-switching unit 145, is input to the first D/A converter 148, and this first D/A converter 148 converts the audio signal, which is the input digital signal, to an analog signal, and outputs the audio signal that has been converted to an analog signal to the outside by way of the audio-output terminal.

Next, details of the construction and operation of the system-control system 160 of the recorder 100 of this embodiment will be explained.

The system-control system 160 of the recorder 100 of this embodiment comprises: a remote-control-beam-receiving unit 162 that receives a light beam that is emitted from the remote-control device 161, which functions as a first programming means and a second programming means and that performs remote control of the recorder 100; a control unit 163 by which the user performs control settings; a display unit 164 that displays information desired by the user such as information for confirming controls by the remote-control device 161 or control unit 163; a system-control unit 166 that sets information required for dubbing programming process (hereafter, referred to as ‘dubbing programming information’) based on information from key input (hereafter, referred to as ‘key-input information’) to the remote-control device 161 or control unit 163 when performing the dubbing programming process, and controls the OSD 146 and generates video information for the dubbing programming information in order to display it on a monitor (not shown in the figures); a memory 165 that stores programs necessary for various operations; and the system-control unit 166 that functions as a judgment means and output means that controls the entire system.

Here, the remote-control device 161 comprises a plurality of keys such as various confirmation buttons and numeric keys, and UP/DOWN and LEFT/RIGHT cursor keys located in the center of the remote-control device 161, for example. Particularly, the UP/DOWN and LEFT/RIGHT cursor keys (hereafter, simply referred to as UP/DOWN keys and LEFT/RIGHT keys) are used when setting the programmed start time and programmed end time in the dubbing programming process described later.

Next, the remote-control-beam-receiving unit 162 receives a beam of light such as an infrared beam that is emitted from the remote-control device 161, and converts that received light beam to a specified signal and outputs it to the control unit 163.

Also, similar to the remote-control device 161, the control unit 163 comprises a plurality of keys such as various confirmation buttons and numeric keys, and UP/DOWN and LEFT/RIGHT keys, and particularly, the UP/DOWN and LEFT/RIGHT keys are used when setting the programmed start time and programmed end time in the dubbing programming process described later.

Also, this control unit 163 outputs a specified signal that is output from the remote-control-beam-receiving unit 162 according to key operation to the system-control unit 166.

The UP/DOWN and LEFT/RIGHT keys of this control unit 163 have the same construction as the UP/DOWN and LEFT/RIGHT keys on the remote-control device 161.

Moreover, the display unit 164 has a beam-emitting unit comprising a plurality of light-emitting elements such as liquid crystals, and it displays information desired by the user such as information for confirming an operation by the remote-control device 161 or control unit 163.

Next, when automatically recording a broadcast program onto the HD 200 or DVD 202 at the preset time, and when performing settings in order to program in advance the process of dubbing the information recorded on the HD 200 to the DVD 203 (hereafter, referred to as the ‘dubbing-programming process’), the dubbing-programming-information-setting unit 300 sets the dubbing-programming information required for the dubbing-programming process based on key-input information entered to the remote-control device 161 or control unit 163, and then it has the OSD 146 generate video information for the programmed program table, and superimpose the dubbing-programming information onto that generated programmed program table, and output it to the outside by way of the video-signal encoder 147 and second D/A converter 149.

The detailed process that is executed by the dubbing-programming-information-setting unit 300 of this embodiment, and details about the video information that shows the dubbing list generated by the OSD 146 will be described later.

Next, together with mainly comprising a central processing unit (CPU), the system-control unit 166 comprises a key-input port, and various input/output ports such as the output port to the display unit 164, and it performs overall control of general functions for reproducing information from or recording information to a HD 200, or reproducing information from or recording information to a DVD 202.

More specifically, based on control key input from the remote-control device 161 or control unit 163, the system-control unit 166 of this embodiment performs control such that the dubbing-programming-information-setting unit 300 sets dubbing-programming information, and performs control such that video information of the dubbing list created by the OSD 146 is output to the outside by way of the video-signal encoder 147 and second D/A converter 149.

Moreover, when performing the dubbing-programming process or when recording a programmed broadcast program onto the HD 200 or DVD 202, the system-control unit 166 reads control programs stored in the memory 165 in order to execute various processes, and temporarily stores information during processing in the memory 165.

(II) Embodiment 1

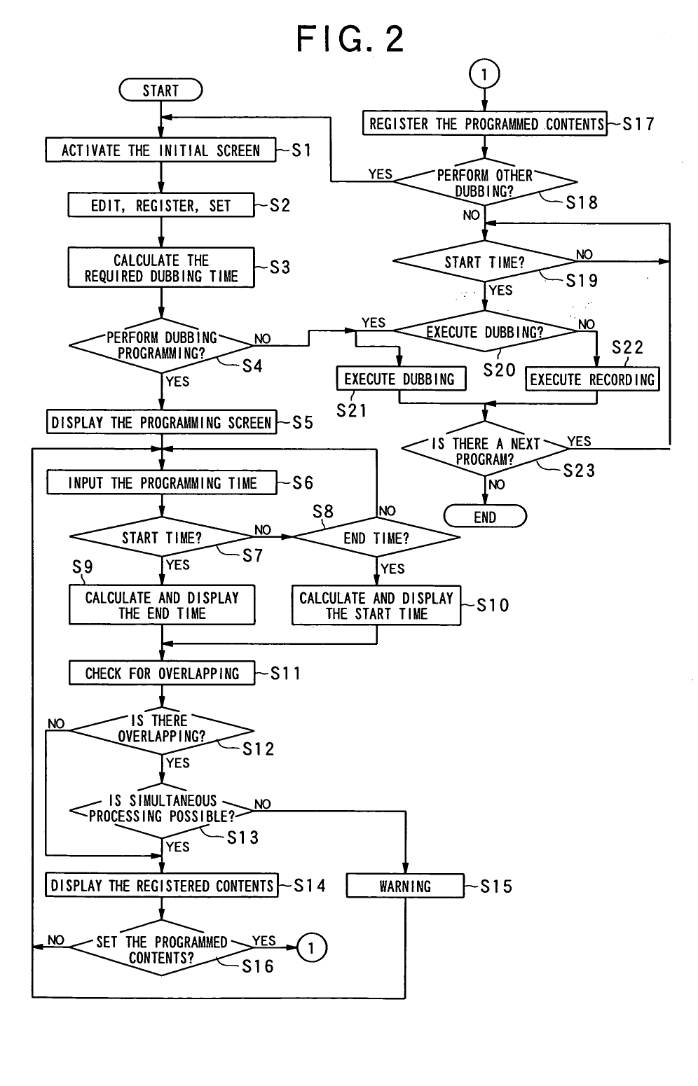

Next, as a first embodiment of the invention, dubbing, including the dubbing-programming process, that is executed by the recorder 100 constructed as described above will be explained in detail using FIG. 2 to FIG. 4.

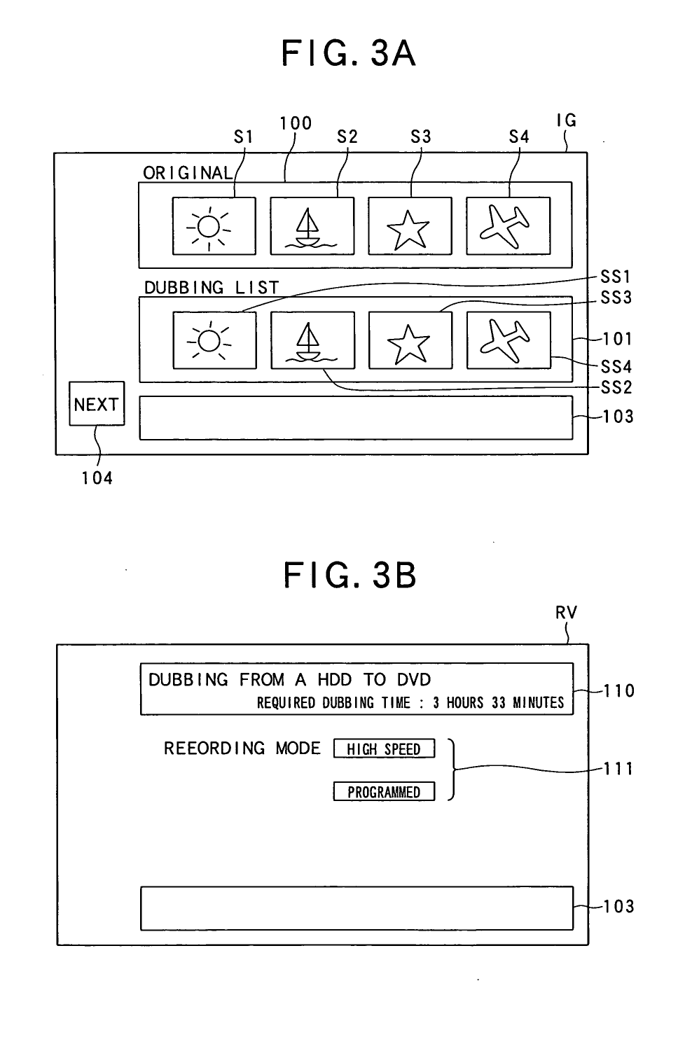

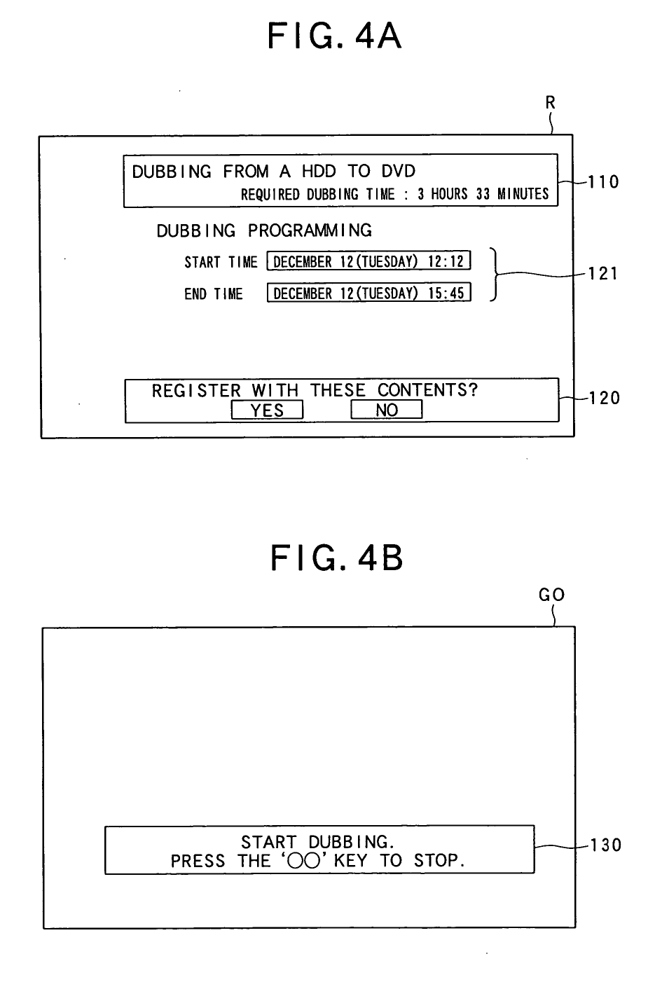

FIG. 2 is a flowchart showing the dubbing of this first embodiment, and FIG. 3 and FIG. 4 are both drawings showing examples of control screens that are displayed on an external display or the like (not shown in the figures) when executing dubbing.

First, the premises for the dubbing process described below will be explained.

In the dubbing process explained below, the recorder 100 of this embodiment is able to execute two kinds of dubbing. The first is called ‘high-speed dubbing’, and more specifically, it is a process of changing the information recorded on the HD 200 as recorded to a recording format and dubbing it onto the DVD 202 without converting the information rate. Also, in this high-speed dubbing, since there is no need for a rate-conversion process, after the information to be dubbed at high speed is detected from the HD 200, it passes in order through the HD drive interface 205, the first drive-switching unit 204, second drive-switching unit 206 and DVD drive interface 207, and then is recorded on to the DVD 202.

On the other hand, the second of the two types of dubbing is called ‘rate-conversion dubbing’, and as its name indicates, it is a process of dubbing the information recorded on the HD 200 to the DVD 202 while converting the information rate to a desired value (in other words, changing the information amount when recorded on the HD 200 to a different amount of information). Also, in this rate-conversion dubbing process, in order to convert the rate, it is necessary to decode the information detected from the HD 200, then convert the rate and encode the information again, so after the information to be dubbed using rate conversion is detected from the HD 200 shown in FIG. 1, it passes in order through the HD drive interface 205, first drive-switching unit 204, de-multiplexer 142, audio decoder 144 and video decoder 143, selection unit 127, video encoder 128 and audio encoder 129, multiplexer 130, second drive-switching unit 206 and DVD drive interface 207, and then is recorded onto the DVD 202.

When recording information to the DVD 202, due to the optical recording method for recording to the DVD 202, it is not possible to execute the normal recording process of recording the received broadcast program and dubbing at the same time.

On the other hand, in the case of the HD 200, when performing high-speed dubbing and recording to the HD 200 at the same time, the video encoder 128 and audio encoder 129 can be used exclusively for the recording process, so the processes can be executed at the same time, however, when performing rate-conversion dubbing and the recording process at the same time, the video encoder 128 and the audio encoder 129 cannot be used by both processes, so the processes cannot be executed at the same time.

Furthermore, before executing dubbing, both the start time and end time for recording are programmed in the recording-programming process for recording a desired broadcast program on to the HD 200 or DVD 202.

With the contents described above as a premise, the dubbing executed in this first embodiment will be explained centered on the dubbing-programming-information-setting unit 300 and system-control unit 166.

As shown in FIG. 2, in the dubbing process of this first embodiment, first, the initial screen for performing the dubbing-programming process included in this dubbing process is displayed on the external display (not shown in the figures) (hereafter, referred to as simply the display) (step S1). Then, by using this displayed screen, the user controls the remote-control device 161 or control unit 163 to select the information to be dubbed, and then registers and confirms the selected information (step S2).

Here, the initial screen IG shown in FIG. 3A is used as the initial screen used in the processing of steps S1 and S2. In this initial screen IG, representative images S1 to S4 (normally called thumbnail images) that clearly show the contents of the information to be dubbed are displayed in the original-information-display field 100 that displays the information recorded on the HD 200 that will become the object of dubbing. The representative images S make it possible for the user to check which information is to be dubbed.

In addition to this, in this initial screen SG, of the information displayed by the representative images in the original-information-display field 100 there are dubbing representative images SS1 to SS4 that correspond to the information selected as the object of dubbing. In the example shown in FIG. 3A, the information recorded on the HD 200 all become the object of dubbing.

Also, in this initial screen IG, a display field 103 for displaying necessary warnings or control-help information (so-called help information), and a transition button 104 for moving to the next process of the dubbing-programming process are displayed.

After registration of the information to be dubbed is complete, next, the time required for dubbing all of the registered information is calculated and temporarily stored in the memory 165 shown in FIG. 1.

Also, after selection and registration of the information to be dubbed is completed, next, whether to execute dubbing of the registered information immediately, or to execute the dubbing-programming process is confirmed (step S4). Also, when immediately starting dubbing of the registered information (step S4: NO), the process moves to execution of the dubbing process, however, in the case of executing the dubbing-programming process for the registered information (step S4: YES), the programming-information screen necessary for this dubbing-programming process is displayed on the display (step S5). The programming-information screen RV shown in FIG. 3B is displayed on the display as this programming-information screen.

Here, the programming-information screen RV comprises: a required-time-display field 110, which displays the amount of time required for dubbing by reading the information that was stored in the memory 165 in step S3; a mode-display field 11, which displays the re-recording mode that executes dubbing; and a display field 103. In the case shown in FIGS. 3A and 3B, high-speed dubbing is executed as programmed.

After the programming information is displayed, next, the programming screen that is used for the actual dubbing-programming process is displayed on the display, and using this screen, the actual dubbing-programming process (steps S6 to S17) is executed.

Here, as shown in FIG. 4A, the programming screen R comprises: a required-time-display field 110; a time-display field 121 that shows the start time and end time for the entire dubbing process; and a confirmation-display field 120 for checking whether or not to set the input and registered contents and displaying information for executing that set process.

Also, in the actual dubbing-programming process using the programming screen R, first, the user enters one of the times (step S6), then the entered time is checked whether or not it is the start time for starting the dubbing process (step S7), and when the input time is not the start time (step S7: NO), then the entered time is checked whether or not it is the end time for ending the dubbing process (step S8), and when the input time is also not the end time (step S8: NO), then it is determined that some kind of mistake was executed, and processing returns to step S6.

On the other hand, in the judgment of step S7, when it is determined that the input time is the start time (step S7: YES), then from the information stored in the memory 165 in step S3 and the input start time information, the end time when dubbing will end is calculated and displayed together with the start time in the time-display field 121 (step S7), and then the process moves to the processing in step S11.

Also, in the judgment in step S8, when it is determined that the input time is the end time (step S8: YES), then from the information stored in the memory 165 in step S3 and the input end time, the start time when dubbing will start is calculated and displayed together with the end time in the time-display field 121 (step S10), and then the process moves to the processing step S11.

Also, after the start time or end time for executing dubbing is entered by either method and the time for performing dubbing is confirmed, then next, it is checked whether or not that confirmed time and the time programmed for recording to the HD 200 or DVD 202 overlap (steps S11, S12).

When any part of the already programmed recording time and the programmed time for dubbing that was input in the processing up to step S10 overlap (step S12: YES), then next, based on the contents of the overlapping recording processes that are to be programmed, it is checked whether or not the overlapping programming processes can be executed at the same time (step S13).

Also, when the programming processes cannot be performed at the same time (step S13: NO), a warning statement indicating that fact is displayed in the display field 103 that is displayed in the place of the confirmation display field 120 in the programming screen R to warn the user (step S15), and the process returns to step S6 and prompts the user to enter another programming time.

However, in the judgment of step S13, when it is determined that the programming processes can be performed at the same time (step S13: YES), then the contents of the currently input programming time (including the start time and end time for dubbing) is displayed in the time-display field 121 in the programming screen R (step S14).

To describe the judgment of step S13 in more detail, first, when the overlapping programming processes are programming processes for recording to the DVD 202 and dubbing, then as described above, processing cannot be performed at the same time, so processing moves to the process of step S15. Also, when the overlapping programming processes are programming processes for recording to the HD 200 and dubbing, then as described above, when that dubbing is high-speed dubbing, both processes can be performed at the same time, so processing moves to the process of step S14, however, when that dubbing is rate-conversion dubbing, then as described above, the processes cannot be performed at the same time, and processing moves to the process of step S15.

In the process of step S14, the contents of the current programming process are displayed, and then the user is prompted to confirm whether or not to set the displayed programming contents by displaying a confirmation-display field 120 as shown in FIG. 4A on the display (step S16), and when input is such that the programming contents are not set (step S16: NO), then processing returns to the process of step S6 and prompts the user to enter another programming time. However, when input is such as to set the programming contents (step S16: YES), then the programming contents are actually stored in the memory 165 and registered (step S17) and then confirmation is performed whether or not to program other dubbing contents (step S18).

When another dubbing-programming process is to be performed (step S18: YES), then processing returns again to step S1 and another dubbing-programming process is executed, however, when dubbing is to be performed using the current programmed contents (step S18: NO), then the time on the timer (not shown in the figures) located in the system-control unit 166 is monitored (step S19).

When it is not yet the programmed start time (either the start time for dubbing or the start time for recording) (step S19: NO), monitoring continues, however, when it is the start time (step S19: YES), then that start time is checked whether it is the start time for dubbing or the start time for the recording process (step S20).

In the judgment of step S20, when the start time is the start time for dubbing, then dubbing is executed while displaying a confirmation screen GO that includes a confirmation field 130 as shown in FIG. 4B (step S21), and when the start time is the start time for the recording process, then similarly, the recording process is executed while displaying the confirmation screen GO (step S22), and when either process ends, the process checks whether or not a next programmed process has been programmed (step S23). When there is a next programmed process (step S23: YES), processing returns to step S19 and that next programmed process is executed, however, when there is no next programmed process (step S23: NO), dubbing of this first embodiment ends.

As explained above, with the dubbing process of this first embodiment, which includes a dubbing-programming process, when the execution time of the recording process to the DVD 202 is programmed such that it overlaps with the execution time of the dubbing process, a notification is given indicating that that operation is prohibited, so by changing the execution time for the dubbing process according to that notification, it is possible to efficiently perform both the recording process and dubbing process to the DVD 202.

Also, when the execution time for a recording process is programmed such that it overlaps the execution time of a rate-conversion dubbing process that requires execution of the same encoding process, a notification is given indicating that that operation is prohibited, so by changing the execution time of the rate-conversion dubbing process according to that notification, it is possible to efficiently execute both the recording process and rate-conversion dubbing process that require execution of the same encoding process.

(III) Embodiment 2

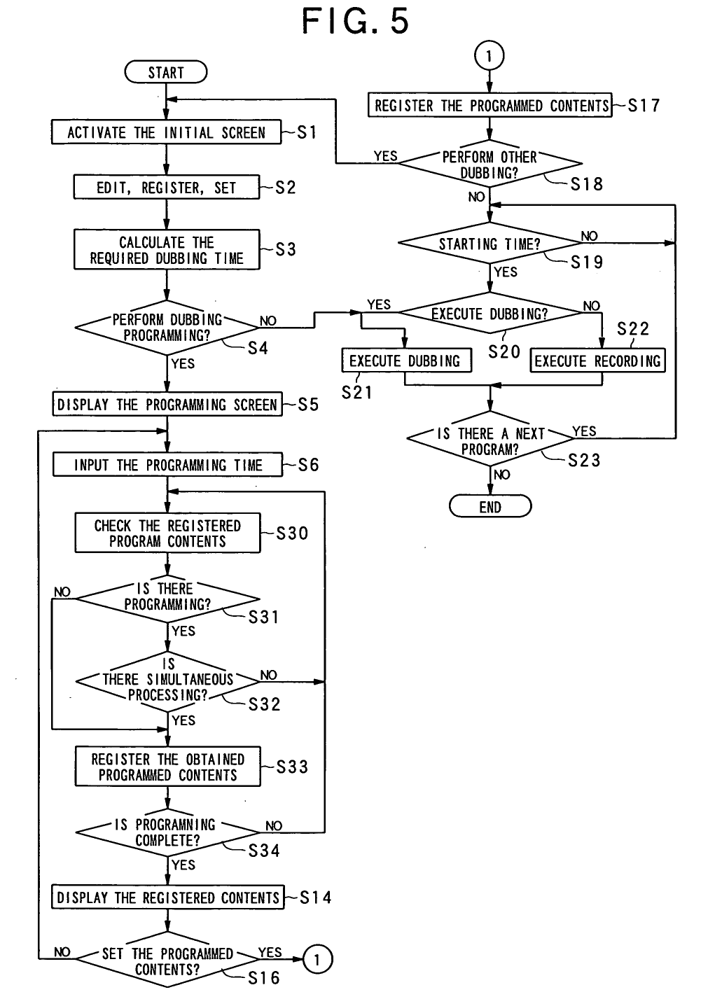

Next, the dubbing process executed by the recorder 100 constructed as described above of another or second embodiment of the invention will be explained in detail using FIG. 5 to FIG. 7.

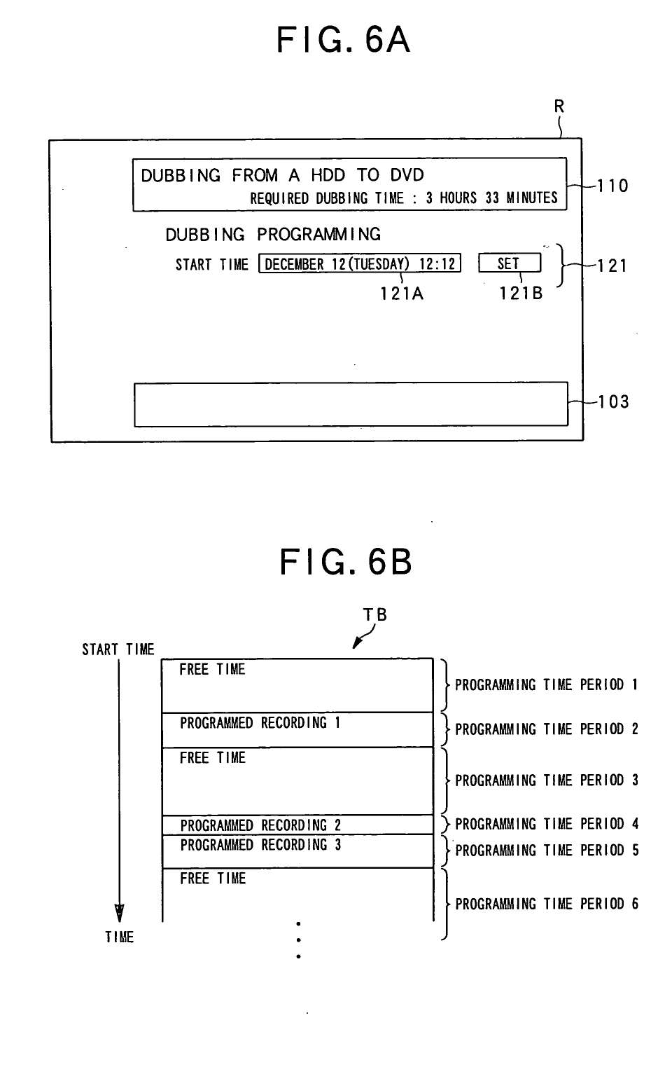

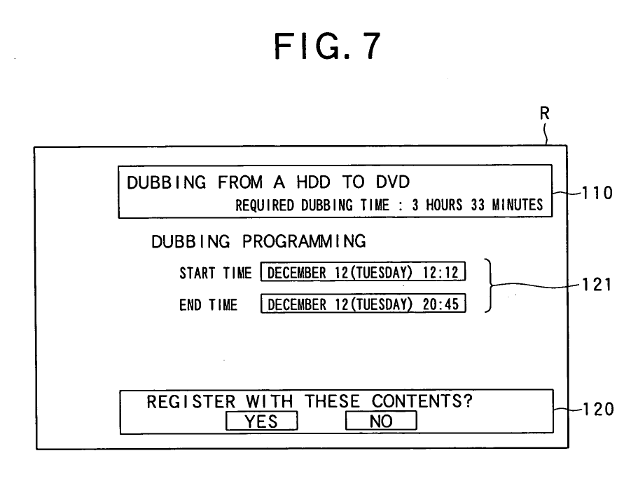

FIG. 5 is a flowchart showing the dubbing process of this second embodiment, and FIG. 6 and FIG. 7 are drawings showing examples of control screens that are displayed on the display during execution of the dubbing process.

In the first embodiment described above, the case was explained in which the programmed time for the recording process was simply compared with the programmed time for the dubbing process, and when they overlapped, the programmed time for the dubbing process was changed, however, in the second embodiment to be explained below, the case is explained in which when the times overlap, the programmed time for the dubbing process is divided up and re-programmed.

In the flowchart shown in FIG. 5, processes that are the same as the dubbing processes in the first embodiment shown in FIG. 2 are given the same step numbers and a detailed explanation of those steps is omitted. Also, in the screen display examples shown in FIG. 6 and FIG. 7, fields that are the same as those in the screen display examples of the first embodiment shown in FIG. 3 and FIG. 4 are given the same numbers and a detailed explanation of them is omitted.

Furthermore, the premises for the dubbing process of this second embodiment are the same as the premises in the first embodiment, so a detailed explanation of them will be omitted.

As shown in FIG. 5, in the dubbing process of this second embodiment, first, the processes of steps S1 to S6, which are the same as those in the first embodiment, are executed (see FIG. 2).

Here, as shown in FIG. 6A, the programming screen used in the processing of step S5 and S6 in this second embodiment comprises: a required-time-display field 110; a time display 120 that includes a start time display field 121A that shows the start time for the dubbing process and a setting icon that is operated when setting that start time; and a confirmation-display screen 103.

After the start time or end time for executing the dubbing process is entered and the time for performing the dubbing process is checked, then the programmed time for recording to the HD 200 or DVD 202 that was programmed beforehand is checked (step S30).

Also, the process checks whether or not there is another programmed recording process during the time period programmed for executing the dubbing process (step S31), and when there is no other programmed recording process, (step S31: NO), then processing moves to the process of step S33 described later; however, when there is another programmed recording process (step S31: YES), then based on the recording process corresponding to that other programmed recording process and the contents of the dubbing process, the processes are checked whether or not they can be executed at the same time (step S32). The judgment criteria used in step S32 is the same as the judgment criteria that is used in the process of step S13 in the first embodiment.

When it is determined that the processes cannot be executed at the same time (step S32: NO), then processing returns to step S30, and the time for executing the dubbing process is divided and the overlap with the other programmed recording process is adjusted so that the dubbing process is executed only in a time that is not programmed for the other recording process.

On the other hand, in the judgment of step S32, when it is determined that the processes can be executed at the same time (step S32: YES), then the contents of the current input programmed time (including the start time and end time for the dubbing process) is stored in memory 165 and registered (step S33), and the process checks whether or not the desired dubbing programming has been completed (step S34). When programming is completed (step S34: YES), the start time and end time corresponding to the programmed contents are displayed in the time-display field 121 in the programming screen R shown in FIG. 7 (step S14).

To explain the process for obtaining programmed times in steps S30 to S34 in more detail, as in the programming information table TB shown in FIG. 6B, the time period starting from the start time for the dubbing process that was entered by the user is checked in order from the start of the time period for whether or not a recording process has already been programmed, and when there is a programmed recording process, the time period for the dubbing process is divided up into time periods other than the time period for the programmed recording process, and the programmed dubbing process is set for those free time periods. In the case shown in FIG. 6B, recording processes have already been programmed for programmed time periods 2, 4 and 5, so programmed time periods 1, 3 and 6 are used as the time periods for the dubbing process which cannot be executed at the same time as the programmed recording processes. In the case where a recording process for recording to the HD 200 is programmed for the same time period as a high-speed dubbing process, since these processes can be executed at the same time, there is no need to divide up the time period for executing the dubbing process.

Also, after the time period for the dubbing process has been saved and the programming screen R is displayed on the display, then as shown in FIG. 7, the end time is programmed at a later time than in the case of the first embodiment when the dubbing process is not divided (see FIG. 4A).

After the start time and end time have been set and the programming screen R is displayed (step S14), the processing of steps S16 to S23, which are the same as the dubbing programming process in the first embodiment, is executed, and the dubbing process of this second embodiment ends.

As was explained above, with the dubbing process of this second embodiment, in addition to the effect of the dubbing process of the first embodiment, when the execution time for the recording process is programmed such that it overlaps the execution time for the dubbing process, the programmed time for executing the dubbing process is changed so that it corresponds to the execution time of the recording process, and free time is used to efficiently end the dubbing process.

Also, since the programmed time for execution of the dubbing process is set to correspond with the execution time for the recording process, it is possible to efficiently complete the dubbing process using the free time.

Furthermore, after the time for starting the dubbing process is input, that dubbing process is executed using the free times after that input time, so it is possible to efficiently execute the dubbing process after the specified start time.

In the second embodiment described above, when there is a new programmed recording process while waiting for the start time (step S19: NO), that new programmed recording process has priority, and construction is possible in which after knowing the contents of the new programmed recording process the process of dividing the programmed contents for the dubbing process is performed again (steps S30 to S34).

In the second embodiment described above, after the time for starting the dubbing process is input, the case of executing the dubbing process using free time after that start time was explained, however, besides this, construction is possible in which after the time for ending the dubbing process has been input the dubbing process is executed using free time in order going back from that time.

With this construction, after the end time for the dubbing process has been input, the dubbing process is executed using the free time in order going back from that time, so it is possible to efficiently execute the dubbing process up to the specified end time.

In this case, when it is not possible to save the time period for the complete dubbing process even going back to the current time, it is necessary for the user to cancel the programming for that dubbing process and perform a new programming process.

Moreover, in each of the embodiments described above, the case of performing dubbing from the HD 200 to the DVD 202 was explained, however, the invention can also be applied to the programming process for executing dubbing from the DVD 202 to the HD 200, or the invention can also be applied to a programming process for executing dubbing between a pair of HD 200 or a pair DVD.

Also, in each of the embodiments described above, the case of applying the invention to dubbing between different media, that is from a HD 200 to a DVD 202, was explained, however, besides this, the invention can also be applied to the case in which re-recording (re-recording to the medium that was reproduced) and programmed recording on the same HD or same DVD overlap.

Furthermore, by recording the programs corresponding to the flowcharts shown in FIG. 2 or FIG. 5 on a information-recording medium such as a flexible disc or HD, or by obtaining the programs via a network such as the Internet and recording them, and then by reading and executing these programs by a general-purpose computer such as a microcomputer, it is possible to have that computer function as the system-control unit 166 of the embodiments.

It should be understood that various alternatives to the embodiment of the invention described herein may be employed in practicing the invention. Thus, it is intended that the following claims define the scope of the invention and that methods and structures within the scope of these claims and their equivalents be covered thereby.

The entire disclosure of Japanese Patent Application No. 2003-201757 filed on Jul. 25, 2003 including the specification, claims, drawings and summary are incorporated herein by reference in its entirety.

1. A information-recording apparatus that performs at least: a detection/recording process of detecting information from one recording medium and recording that detected information to another recording medium, a detection/recording process of re-recording information detected from said recording medium onto that said medium itself, or a detection/recording process of re-recording information detected from said other recording medium onto that said other medium itself; a recording process of recording information onto said recording medium; and a recording process of recording information onto said other medium; and for which executing at least said recording process of recording onto said other medium or said detection/recording process of using said other recording medium at the same time is prohibited, comprising:
a first programming device that is used for programming the execution of said recording processes of recording to said recording medium and said other recording medium;
a second programming device that is used for programming the execution of said detection/recording process that uses said other recording medium by entering start time information that indicates the start time for executing said detection/recording process that uses said other recording medium;
a calculation device which calculates the end time for said detection/recording process that uses said other recording medium based on said information that is the object of said detection/recording process that uses said other medium, and input start time information, when execution of said detection/recording process that uses said other recording medium is programmed;
a judgment device which determines, based on end time information that indicates said calculated end time and said entered start time information, whether or not said recording process of recording onto said other recording medium and said detection/recording process that uses said other recording medium are programmed to be executed at the same time; and
an output device which outputs notification information for notifying that execution of said recording process and said detection/recording process that uses said other recording medium at the same time is prohibited, when said recording process of recording onto said other recording medium and said detection/recording process that use said other recording medium are programmed to be executed at the same time.

2. The information-recording apparatus according to claim 1, wherein when recording of said information onto said recording medium accompanies an encoding process;
said judgment device which determines, based on end time information that indicates said calculated end time and input start time information, whether or not said recording process of recording onto said recording medium and said detection/recording process that uses said recording medium are programmed to be executed at the same time; and
when said recording process of recording onto said recording medium and said detection/recording process that uses said recording medium are programmed to be executed at the same time, further determines whether or not said detection/recording process that uses said recording medium is performed together with a decoding process and said encoding process that is performed on said information that becomes the object of said detection/recording process that uses said recording medium; and wherein
said output device which outputs notification information for notifying that execution of the recording process of recording to said recording medium and said detection/recording process that uses that recording medium at the same time is prohibited, when said recording process of recording onto said recording medium and said detection/recording process that uses said recording medium are programmed to be executed at the same time, and when it is determined that said detection/recording process that uses said recording medium is performed together with said decoding process and said encoding process.

3. The information-recording apparatus according to claim 1, further comprising:
a search device which searches for an executable time, which is a time when it is possible to execute one of said detection/recording processes, based on the programmed time for executing one of the process when at least said recording process of recording onto said other recording medium or said recording process of recording onto said recording medium, and one of said detection/recording processes are programmed to be executed at the same time; and
a change device which changes the contents of the programmed time for executing one of said detection/recording processes such that said detection/recording process is executed at the found executable time.

4. The information-recording apparatus according to claim 3, wherein
when a plurality of said executable times are found, said change device changes said programmed contents such that one of said detection/recording processes is divided and executed according to the plurality of said executable times.

5. The information-recording apparatus according to claim 4, wherein
when said start time information is input, said change device changes said programmed contents such that one of said detection/recording processes is divided and executed in order from the earliest executable time of said executable times after said start time.

6. The information-recording apparatus according to claim 4 further comprising
a third programming device which is used for programming execution of one of said detection/recording processes by entering end time information indicating the end time for execution of one of said detection/recording processes; and wherein
when said end time information is entered, said change device changes said programmed contents such that one of said detection/recording processes is divided and executed in order going back to said executable time indicating the earliest time of executable times before said end time.

7. A information-recording method that performs at least: a detection/recording process of detecting information from one recording medium and recording that detected information to other recording medium, a detection/recording process of re-recording information detected from said recording medium onto that said medium itself, or a detection/recording process of re-recording information detected from said other recording medium onto that said other medium itself; a recording process of recording information onto said recording medium; and a recording process of recording information onto said other medium; and for which executing at least said recording process of recording onto said other medium or said detection/recording process of using said other recording medium at the same time is prohibited, comprising:
a first programming process of programming the execution of said recording processes of recording to said recording medium and said other recording medium;
a second programming process of programming the execution of said detection/recording process that uses said other recording medium by entering start time information that indicates the start time for executing said detection/recording process that uses said other recording medium;
a calculation process of calculating the end time for said detection/recording process that uses said other recording medium based on said information that is the object of said detection/recording process that uses said other medium, and input start time information, when execution of said detection/recording process that uses said other recording medium is programmed;
a judgment process of determining, based on end time information that indicates said calculated end time and input start time information, whether or not said recording process of recording onto said other recording medium and said detection/recording process that uses said other recording medium are programmed to be executed at the same time; and
an output process of outputting notification information for notifying that execution of said recording process and said detection/recording process that uses said other recording medium at the same time is prohibited, when said recording process of recording onto said other recording medium and said detection/recording process that use said other recording medium are executed at the same time.

8. A information-recording program that makes a computer included in a information-recording apparatus that performs at least: a detection/recording process of detecting information from one recording medium and recording that detected information to other recording medium, a detection/recording process of re-recording information detected from said recording medium onto that said medium itself, or a detection/recording process of re-recording information detected from said other recording medium onto that said other medium itself; a recording process of recording information onto said recording medium; and a recording process of recording information onto said other medium; and for which executing at least said recording process of recording onto said other medium or said detection/recording process of using said other recording medium at the same time is prohibited, function as:
a first programming device that is used for programming the execution of said recording processes of recording to said recording medium and said other recording medium;
a second programming device that is used for programming the execution of said detection/recording process that uses said other recording medium by entering start time information that indicates the start time for executing said detection/recording process that uses said other recording medium;
a calculation device of calculating the end time for said detection/recording process that uses said other recording medium based on said information that is the object of said detection/recording process that uses said other medium, and input start time information, when execution of said detection/recording process that uses said other recording medium is programmed;
a judgment device of determining, based on end time information that indicates said calculated end time and input start time information, whether or not said recording process of recording onto said other recording medium and said detection/recording process that uses said other recording medium are programmed to be executed at the same time; and
an output device of outputting notification information for notifying that execution of said recording process and said detection/recording process that uses said other recording medium at the same time is prohibited, when said recording process of recording onto said other recording medium and said detection/recording process that use said other recording medium are executed at the same time.

9. An information recording medium in which a information-recording program is recorded in a readable way by a recording computer included in an information-recording apparatus that performs at least: a detection/recording process of detecting information from one recording medium and recording that detected information to other recording medium, a detection/recording process of re-recording information detected from said recording medium onto that said medium itself, or a detection/recording process of re-recording information detected from said other recording medium onto that said other medium itself; a recording process of recording information onto said recording medium; and a recording process of recording information onto said other medium; and for which executing at least said recording process of recording onto said other medium or said detection/recording process of using said other recording medium at the same time is prohibited, the information-recording program causing the recording computer to function as:
a first programming device that is used for programming the execution of said recording processes of recording to said recording medium and said other recording medium;
a second programming device that is used for programming the execution of said detection/recording process that uses said other recording medium by entering start time information that indicates the start time for executing said detection/recording process that uses said other recording medium;
a calculation device of calculating the end time for said detection/recording process that uses said other recording medium based on said information that is the object of said detection/recording process that uses said other medium, and input start time information, when execution of said detection/recording process that uses said other recording medium is programmed;
a judgment device of determining, based on end time information that indicates said calculated end time and input start time information, whether or not said recording process of recording onto said other recording medium and said detection/recording process that uses said other recording medium are programmed to be executed at the same time; and
an output device of outputting notification information for notifying that execution of said recording process and said detection/recording process that uses said other recording medium at the same time is prohibited, when said recording process of recording onto said other recording medium and said detection/recording process that use said other recording medium are executed at the same time.
